(19) United States
(12) Patent Application Publication
(10) Pub. No.: US 2025/0389601 A1
(43) Pub. Date: Dec. 25, 2025

(54) DETECTION DEVICE

(71) Applicant: Japan Display Inc., Tokyo (JP)

(72) Inventors: Yosuke HYODO, Tokyo (JP); Masatomo HISHINUMA, Tokyo (JP)

(21) Appl. No.: 19/237,463

(22) Filed: Jun. 13, 2025

(30) Foreign Application Priority Data
Jun. 20, 2024 (JP) 2024-099641

(51) Int. Cl. G01L 5/161

(52) U.S. Cl. CPC G01L 5/161

(57) ABSTRACT

According to an aspect, a detection device includes an array substrate and a sensor layer stacked in the order as stated. A direction in which the sensor layer is disposed when viewed from the array substrate is a first stacking direction. A direction opposite to the first stacking direction is a second stacking direction. The array substrate includes: a first surface facing in the first stacking direction; a plurality of recessed surfaces recessed from the first surface in the second stacking direction; and a plurality of detection electrodes provided on the respective recessed surfaces. The sensor layer is formed by curing conductive resin material printed on the first surface. The sensor layer and the detection electrodes are separated from each other.

### CROSS-REFERENCE TO RELATED APPLICATION

This application claims the benefit of priority from Japanese Patent Application No. 2024-099641 filed on Jun. 20, 2024, the entire contents of which are incorporated herein by reference.

### BACKGROUND

### 1. Technical Field

What is disclosed herein relates to a detection device.

### 2. Description of the Related Art

It is known that there are detection devices which are devices that detect a load (force) acting vertically on a detection surface. Such a detection device includes a protective layer, a sensor layer, and an array substrate stacked in this order from the detection surface. One surface of the protective layer serves as the detection surface. The array substrate described in Japanese Patent Application Laid-open Publication No. 2023-109115 includes detection electrodes and common electrodes disposed on the surface facing the sensor layer. The sensor layer has a facing surface that faces and is separated from each of the detection electrodes and the common electrodes. When force is applied to the detection surface, the facing surface moves toward the detection electrode and the common electrode and comes into contact with the detection electrode and the common electrode. As a result, a current flows from the common electrode to the detection electrode via the sensor layer. When the force applied to the detection surface is large, the contact area of the facing surface in contact with the common electrode and the detection electrode increases. As a result, the current flowing from the common electrode to the detection electrode increases.

The protective layer may be a protective film made of polyethylene terephthalate (PET), polyimide (PI), or the like. The detection device may be manufactured by printing the sensor layer on the protective film and stacking the protective film with the sensor layer printed thereon on the array substrate. According to this manufacturing method, the linear expansion coefficients of the protective film and the sensor layer are different from each other, thereby causing the protective film with the sensor layer printed thereon to warp. When such a warp occurs, the distance from the facing surface to the detection electrode and the common electrode increases, and small force may fail to be detected. By contrast, if the sensor layer is printed on the array substrate, the sensor layer is in contact with the detection electrode. In other words, the detection device fails to employ the structure that increases or decreases the contact area of the sensor layer in contact with the detection electrode in proportion to the magnitude of the applied force. For this reason, the sensor layer is required to be separated from the detection electrode if it is printed on the array substrate.

For the foregoing reasons, there is a need for a detection device including a sensor layer printed on an array substrate and separated from a detection electrode.

### SUMMARY

According to an aspect, a detection device includes an array substrate and a sensor layer stacked in the order as stated. A direction in which the sensor layer is disposed when viewed from the array substrate is a first stacking direction. A direction opposite to the first stacking direction is a second stacking direction. The array substrate includes: a first surface facing in the first stacking direction; a plurality of recessed surfaces recessed from the first surface in the second stacking direction; and a plurality of detection electrodes provided on the respective recessed surfaces. The sensor layer is formed by curing conductive resin material printed on the first surface. The sensor layer and the detection electrodes are separated from each other.

### BRIEF DESCRIPTION OF THE DRAWINGS

FIG. 1 is a view of a detection device according to a first embodiment viewed from a position facing a detection surface;

FIG. 2 is a schematic of a section of the detection device according to the first embodiment, and more specifically a schematic sectional view along line II-II of FIG. 4;

FIG. 3 is a view of part of a first surface of an array substrate according to the first embodiment viewed from a sensor layer;

FIG. 4 is an enlarged view of one individual detection region on the first surface of the array substrate according to the first embodiment viewed from the sensor layer side;

FIG. 5 is a circuit diagram of a circuit configuration of the detection device according to the first embodiment;

FIG. 6 is a sectional view schematically illustrating a state where force is applied to the detection device according to the first embodiment;

FIG. 7 is a sectional view schematically illustrating a state where force larger than that in FIG. 6 is applied;

FIG. 8 is a schematic of a section of the detection device according to a first modification;

FIG. 9 is a view of part of the first surface of the array substrate according to a second modification viewed from the sensor layer side;

FIG. 10 is a sectional view of a recessed surface of the array substrate according to the second modification taken along the stacking direction;

FIG. 11 is a sectional view schematically illustrating a state where force is applied to the detection device according to the second modification;

FIG. 12 is a sectional view of the array substrate according to a third modification taken along the stacking direction;

FIG. 13 is a sectional view of the array substrate according to a fourth modification taken along the stacking direction;

FIG. 14 is a sectional view of the array substrate according to a fifth modification taken along the stacking direction; and

FIG. 15 is a sectional view of the array substrate according to a sixth modification taken along the stacking direction.

### DETAILED DESCRIPTION

Exemplary aspects (embodiments) to embody a detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present invention and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be appropriately omitted.

To describe an aspect regarding a certain structure on which or above which another structure is disposed in the present specification and the claims, when “on” is simply used, it indicates both the following cases unless otherwise noted: a case where the other structure is disposed directly on and in contact with the certain structure, and a case where the other structure is disposed above the certain structure with yet another structure interposed therebetween.

### First Embodiment

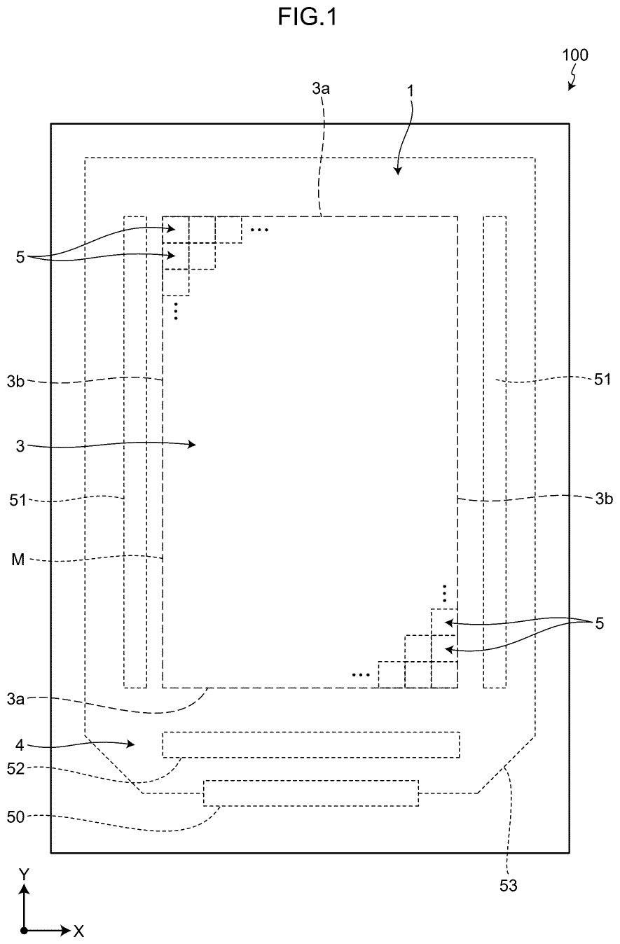

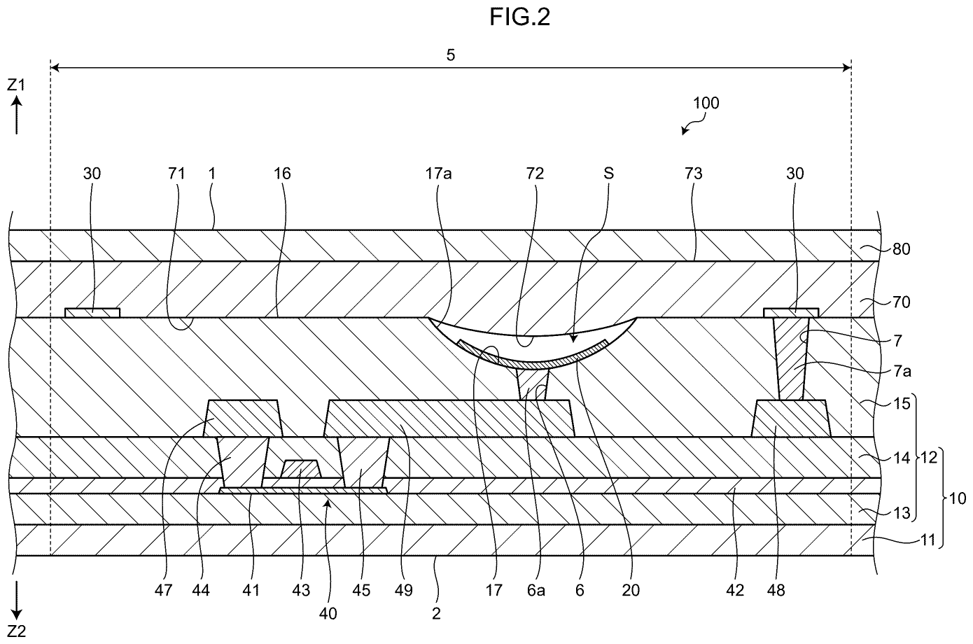

FIG. 1 is a view of a detection device according to a first embodiment viewed from a position facing a detection surface. A detection device 100 is a device that detects force acting on a detection surface 1. As illustrated in FIG. 1, the detection device 100 is formed in a flat plate shape. The detection device 100 has a flat front surface (detection surface 1) and a flat back surface 2 (not illustrated in FIG. 1; refer to FIG. 2). The detection device 100 has a rectangular shape when viewed in the direction normal to the detection surface 1.

The detection surface 1 is divided into a detection region 3 in which force can be detected and a peripheral region 4 in which force cannot be detected. The detection region 3 is positioned at the center of the detection surface 1. The peripheral region 4 is formed in a frame shape and surrounds the outer periphery of the detection region 3.

The detection region 3 is formed in a rectangular shape when viewed in the direction normal to the detection surface 1. Therefore, an outer frame M of the detection region 3 has a pair of short sides 3a and a pair of long sides 3b. In the following description, the direction parallel to the detection surface 1 and parallel to the short side 3a is referred to as a first direction X. The direction parallel to the detection surface 1 and parallel to the long side 3b is referred to as a second direction Y. Thus, the second direction Y is a direction orthogonal to (intersecting) the first direction X. The direction parallel to the detection surface 1 may be hereinafter referred to as a planar direction.

The detection region 3 is divided into a plurality of individual detection regions 5. In other words, the detection region 3 is composed of the individual detection regions 5, and force values are detected in the respective individual detection regions 5. When viewed in the direction normal to the detection surface 1, the individual detection region 5 has a square shape. The individual detection regions 5 are arrayed in the first direction X and the second direction Y.

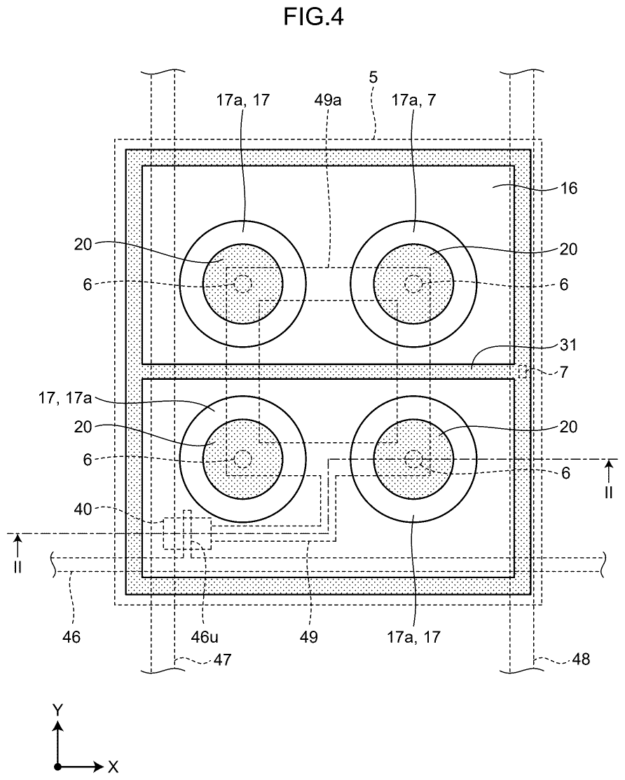

FIG. 2 is a schematic of a section of the detection device according to the first embodiment, and more specifically a schematic sectional view along line II-II of FIG. 4. As illustrated in FIG. 2, the detection device 100 includes an array substrate 10, a sensor layer 70, and a protective layer 80 stacked in this order. In the following description, the direction in which the array substrate 10, the sensor layer 70, and the protective layer 80 are stacked is referred to as a stacking direction. The direction normal to the detection surface 1 described above is the same meaning as the stacking direction. A direction from the first substrate 10 toward the sensor layer 70 along the stacking direction is referred to as a first stacking direction Z1, and a direction opposite thereto is referred to as a second stacking direction Z2. Viewing in the first stacking direction Z1 may be referred to as plan view.

The array substrate 10 includes a base 11 and an array layer 12 that is formed on a side of the base 11 in the first stacking direction Z1. The base 11 is a plate-like member that supports the array layer 12 and has an insulating property. The material of the base 11 is not particularly limited. The base 11 may be a flexible substrate made of polyimide, for example. The surface of the base 11 facing in the second stacking direction Z2 serves as the back surface 2 of the detection device 100.

The array layer 12 includes a first insulating layer 13, a second insulating layer 14, and a third insulating layer 15 stacked in this order on the surface of the base 11 facing in the first stacking direction Z1. The space between the first insulating layer 13 and the second insulating layer 14 is provided with a gate insulating film 42 of a transistor 40, which will be described later.

The first insulating layer 13, the second insulating layer 14, and the third insulating layer 15 are made of insulating material. The insulating material may be either inorganic or organic material. The third insulating layer 15 is a layer (planarization film) for planarizing a first surface 16 of the array layer 12 in the first stacking direction Z1. While the array layer 12 according to the embodiment includes three insulating layers, the number of insulating layers according to the present disclosure is not particularly limited.

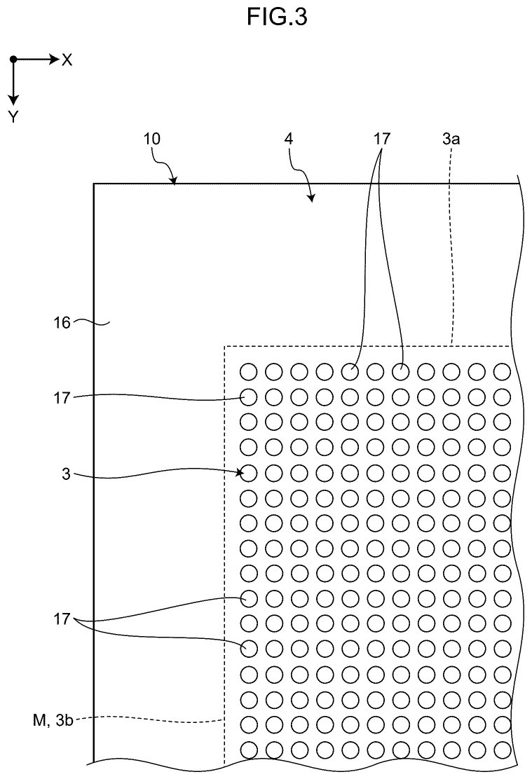

The first surface 16 of the array layer 12 is provided with a recessed surface 17, a detection electrode 20, and a common electrode 30. The recessed surface 17 is recessed from the first surface 16 in the second stacking direction Z2. The recessed surface 17 is formed in a hemispherical shape. Therefore, the recessed surface 17 has a circular shape in plan view (refer to FIG. 3).

FIG. 3 is a view of part of the first surface of the array substrate according to the first embodiment viewed from the sensor layer. In FIG. 3, the detection electrodes 20 and the common electrodes 30 are not illustrated to make the recessed surfaces 17 easier to see. As illustrated in FIG. 3, the recessed surfaces 17 are formed in the area overlapping the detection region 3. In other words, the recessed surfaces 17 are not formed in the area overlapping the peripheral region 4. Thus, the first surface 16 has a fine uneven structure in the area overlapping the detection region 3 and is hard to wet (water-repellent).

As illustrated in FIG. 2, the detection electrode 20 is formed on the recessed surface 17. By contrast, the common electrode 30 is formed on the first surface 16. The detection electrode 20 and the common electrode 30 are metal films made of metal material, such as indium tin oxide (ITO), and formed on the recessed surface 17 and the first surface 16, respectively. Because the recessed surface 17 has a hemispherical shape, the detection electrode 20 formed on the recessed surface 17 also has a hemispherical shape.

FIG. 4 is an enlarged view of one individual detection region on the first surface of the array substrate according to the first embodiment viewed from the sensor layer side. In FIG. 4, the detection electrode 20 and the common electrode 30 are shaded with dots to make them easier to see.

As illustrated in FIG. 4, one individual detection region 5 has four recessed surfaces 17. In other words, one individual detection region 5 is provided with four detection electrodes 20. The detection electrode 20 has a circular shape in plan view. The detection electrode 20 is disposed at the center of the recessed surface 17 and is separated from an edge portion 17a of the recessed surface 17.

Each common electrode 30 is formed in a corresponding one of the individual detection regions 5. The common electrode 30 is formed in a quadrilateral frame shape in plan view. The common electrode 30 surrounds the outside of the four recessed surfaces 17 (four detection electrodes 20). The common electrode 30 is provided with an extension common electrode 31 extending in the first direction X at the center of the individual detection region 5 in the second direction Y.

As illustrated in FIG. 4, a first contact hole 6 extending in the second stacking direction Z2 is formed at the center of the recessed surface 17. A second contact hole 7 extending in the second stacking direction Z2 is formed in the area overlapping the common electrode 30 on the first surface 16. As illustrated in FIG. 2, the first contact hole 6 is provided with a first contact portion 6a coupled to the detection electrode 20. The second contact hole 7 is provided with a second contact portion 7a coupled to the common electrode 30. The following describes a circuit configuration formed in the array layer 12 of the array substrate 10.

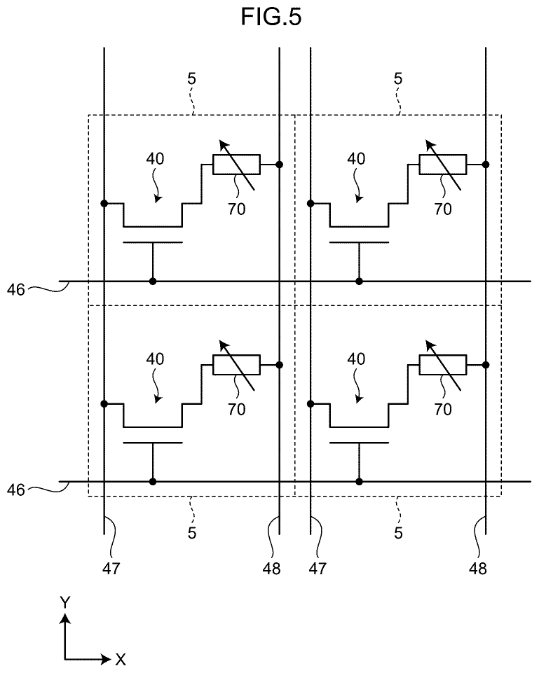

FIG. 5 is a circuit diagram of a circuit configuration of the detection device according to the first embodiment. As illustrated in FIG. 5, the array layer 12 is provided with the transistor 40, a gate line 46, a signal line 47, a reference potential lines 48, a coupling member 50 (refer to FIG. 1), a gate line drive circuit 51 (refer to FIG. 1), a signal line selection circuit 52 (refer to FIG. 1), and a common line 53 (refer to FIG. 1). A plurality of the transistors 40, a plurality of the gate lines 46, a plurality of the signal lines 47, and a plurality of the reference potential lines 48 are formed in the array layer 12 (array substrate 10).

The transistor 40 is a switching element. The transistors 40 are provided to the respective individual detection regions 5. As illustrated in FIG. 2, the transistor 40 includes a semiconductor layer 41, the gate insulating film 42, a gate electrode 43, a drain electrode 44, and a source electrode 45. The end of the source electrode 45 in the first stacking direction Z1 is coupled to a coupling line 49. The coupling line 49 extends in the planar direction (refer to FIG. 4) and is coupled to the first contact portion 6a. Therefore, the source electrode 45 is coupled to the detection electrode 20 via the coupling line 49 and the first contact portion 6a. As illustrated in FIG. 4, one end of the coupling line 49 is provided with an annular wiring line 49a having a quadrilateral frame shape. The annular wiring line 49a is coupled to all the four first contact portions 6a (four detection electrodes 20) disposed in one individual detection region 5.

As illustrated in FIG. 5, each of the gate lines 46 extends in the first direction X. The gate lines 46 are arrayed in the second direction Y. As illustrated in FIG. 4, the gate line 46 is provided with a branch 46u extending in the second direction Y. The branch 46u is provided to each individual detection region 5. The gate line 46 is coupled to the gate electrodes 43 (refer to FIG. 2) of the respective transistors 40 arrayed in the first direction X via the branches 46u.

As illustrated in FIG. 5, each of the signal lines 47 extends in the second direction Y. The signal lines 47 are arrayed in the first direction X. The signal line 47 is coupled to the drain electrodes 44 (refer to FIG. 2) of the respective transistors 40 arrayed in the second direction Y.

As illustrated in FIG. 5, each of the reference potential lines 48 extends in the second direction Y. The reference potential lines 48 are arrayed in the first direction X. As illustrated in FIG. 2, the reference potential line 48 is coupled to the second contact portion 7a of the common electrode 30.

As illustrated in FIG. 1, the coupling member 50, the gate line drive circuit 51, the signal line selection circuit 52, and the common line 53 are disposed in the peripheral region 4 in the array layer 12. The coupling member 50 couples the detection device 100 to a drive integrated circuit (IC) disposed outside the detection device 100. The drive IC may be mounted as a chip on film (COF) on a flexible printed circuit board or a rigid circuit board coupled to the coupling member 50. Alternatively, the drive IC may be mounted as a chip on glass (COG) in the peripheral region 4 of the array substrate 10.

The gate line drive circuits 51 are circuits that drives the gate lines 46 (refer to FIG. 5) based on various control signals from the drive IC. The gate line drive circuits 51 sequentially or simultaneously select the gate lines 46 and supply gate drive signals to the selected gate lines 46.

The signal line selection circuit 52 is a switch circuit that sequentially or simultaneously selects the signal lines 47 (refer to FIG. 5). The signal line selection circuit 52 is a multiplexer, for example. The signal line selection circuit 52 couples the selected signal lines 47 to the drive IC based on selection signal supplied from the drive IC.

The common line 53 is coupled to the drive IC via the coupling member 50 and is supplied with a certain amount of current from the drive IC. The common line 53 extends along the peripheral region and has an annular (frame-like) shape. The common line 53 is coupled to the reference potential line 48. Therefore, the common electrode 30 is supplied with a certain amount of current.

As illustrated in FIG. 2, the sensor layer 70 is made of resin material having conductivity (hereinafter referred to as conductive resin material). The sensor layer 70 is formed by being printed on the first surface 16 of the array substrate 10 and has a planar shape along the first surface 16. In other words, the sensor layer 70 is formed by applying pasty conductive resin material to the first surface 16 and curing it. Therefore, a surface 71 of the sensor layer 70 facing in the second stacking direction Z2 is welded to the first surface 16.

The first surface 16 has a plurality of recessed surfaces 17 in the area overlapping the detection region 3 (refer to FIG. 3). Therefore, the first surface 16 is water-repellent, and the conductive resin material applied to the first surface 16 does not move along the first surface 16 (does not spread toward the recessed surface 17). In other words, the part of the surface 71 of the sensor layer 70 facing the recessed surface 17 cures while maintaining the surface tension. As a result, the part of the surface 71 of the sensor layer 70 facing the recessed surface 17 has a protruding surface 72 protruding in the second stacking direction Z2 with respect to the surface 71.

The protruding surface 72 formed by the configuration described above is separated from the detection electrode 20. An internal space S is formed on the recessed surface 17. The protruding surface 72 may possibly adhere to the part near the edge portion 17a of the recessed surface 17 because it protrudes in the second stacking direction Z2. The detection electrode 20 according to the present embodiment, however, is not provided on the edge portion 17a of the recessed surface 17. In other words, the sensor layer 70 (protruding surface 72) and the detection electrode 20 according to the present embodiment are reliably separated from each other.

As illustrated in FIG. 2, the protective layer 80 is a layer provided on a surface 73 of the sensor layer 70 in the first stacking direction Z1 and is made of insulating material. The surface of the protective layer 80 in the first stacking direction Z1 serves as the detection surface 1.

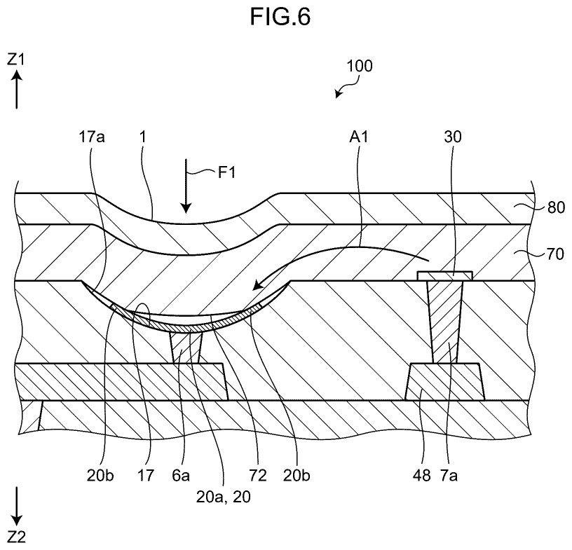

FIG. 6 is a sectional view schematically illustrating a state where force is applied to the detection device according to the first embodiment. Next, an example of the operations of the detection device 100 is described. As illustrated in FIG. 6, when force F1 is applied to the detection surface 1, the protective layer 80 and the sensor layer 70 in the individual detection region 5 to which the force F1 is applied, deform in the second stacking direction Z2. Part of the protruding surface 72 of the sensor layer 70 comes into contact with the detection electrode 20. As a result, a current flows from the common electrode 30 to the detection electrode 20 via the sensor layer 70 (refer to arrow A1 in FIG. 5).

The detection electrode 20 according to the present embodiment has a hemispherical shape, and an edge portion 20b of the detection electrode 20 is positioned in the first stacking direction Z1 with respect to a center 20a of the detection electrode 20. In the example illustrated in FIG. 6, the protruding surface 72 of the sensor layer 70 is in contact only with the edge portion 20b of the detection electrode 20.

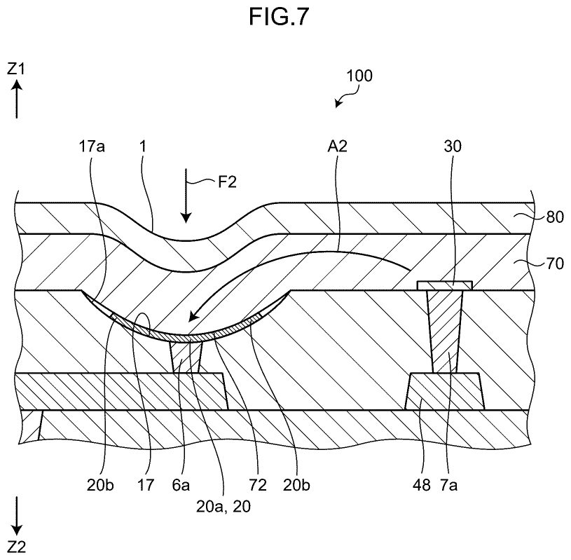

FIG. 7 is a sectional view schematically illustrating a state where force larger than that in FIG. 6 is applied. As illustrated in FIG. 7, when force F2 applied to the detection surface 1 is larger, the amount of movement (amount of deformation) of the sensor layer 70 in the second stacking direction Z2 is also larger. Therefore, the protruding surface 72 comes into contact not only with the edge portion 20b of the detection electrode 20 but also with the center 20a of the detection electrode 20. In other words, the contact area between the sensor layer 70 and the detection electrode 20 increases, and the amount of current flowing from the common electrode 30 to the detection electrode 20 increases (refer to arrow A2 in FIG. 7).

An electrical signal (current value) input to the detection electrode 20 is output by the signal line 47. Based on the magnitude of the current value, the load applied to the individual detection region 5 is derived. When the application of the forces F1 and F2 is cancelled, the sensor layer 70 returns to its original shape. In other words, the sensor layer 70 moves away from the detection electrode 20. Therefore, no current flows to the detection electrode 20, and no force is detected.

As described above, the sensor layer 70 printed on the first surface 16 of the array substrate 10 according to the present embodiment is separated from the detection electrode 20. Therefore, the present embodiment can employ the structure in which the contact area of the sensor layer 70 in contact with the detection electrode 20 increases or decreases in proportion to the magnitude of the applied force.

While the first embodiment has been described above, the present disclosure is not limited to the example described in the first embodiment. For example, the common electrode 30 is formed on the first surface 16 of the array substrate 10, but it may be provided between the sensor layer 70 and the protective layer 80. While four recessed surfaces 17 (four detection electrodes 20) are provided to one individual detection region 5 according to the present embodiment, one recessed surface 17 (detection electrode 20) may be provided in the present disclosure, and the number of recessed surfaces 17 (detection electrode 20) is not particularly limited.

While the detection electrode 20 is provided away from the edge portion 17a of the recessed surface 17, the detection electrode according to the present disclosure may be provided on the edge portion 17a of the recessed surface 17 as long as it can be prevented from coming into contact with the sensor layer 70. To more reliably prevent the detection electrode 20 and the sensor layer 70 from coming into contact with each other, a detection device 100A according to the first modification described below may be employed. The following describes the modifications focusing on the differences from the first embodiment.

### First Modification

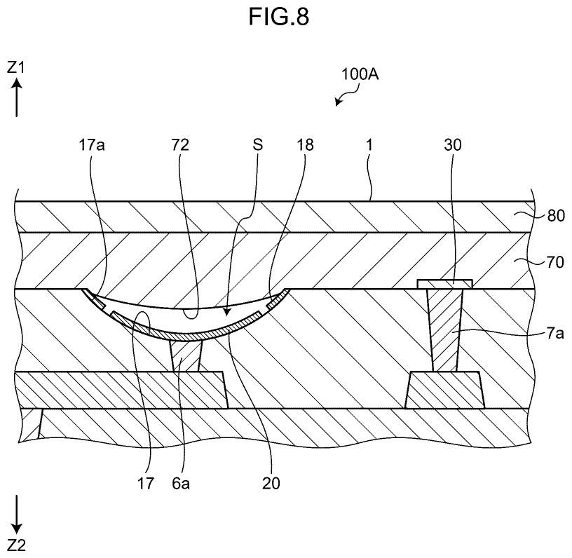

FIG. 8 is a schematic of a section of the detection device according to the first modification. The detection device 100A according to the first modification is different from the first embodiment in that a film 18 is provided on the edge portion 17a of the recessed surface 17. The film 18 is made of fluorine-based polyimide. The film 18 has an annular shape along the edge portion 17a. The film 18 made of fluorine-based polyimide is highly water-repellent. According to the first modification, the part of the sensor layer 70 facing the recessed surface 17 is less likely to spread from the first surface 16 toward the edge portion 17a of the recessed surface 17. In other words, the part of the surface 71 of the sensor layer 70 facing the recessed surface 17 more reliably cures while maintaining the surface tension. Therefore, the detection device 100A can be manufactured in which the sensor layer 70 and the detection electrode 20 are separated from each other.

While the first modification has been described above, the material of the film 18 according to the present disclosure simply needs to be highly water-repellent material and is not limited to fluorine-based polyimide. While the film 18 is provided only on the edge portion 17a of the recessed surface 17, it may extend toward the first surface 16.

While the recessed surface 17 according to the first embodiment has a hemispherical shape, the recessed surface 17 according to the present disclosure simply needs to be recessed from the first surface 16, and its shape is not particularly limited. The recessed surface 17 may have a shape described in the second modification below.

### Second Modification

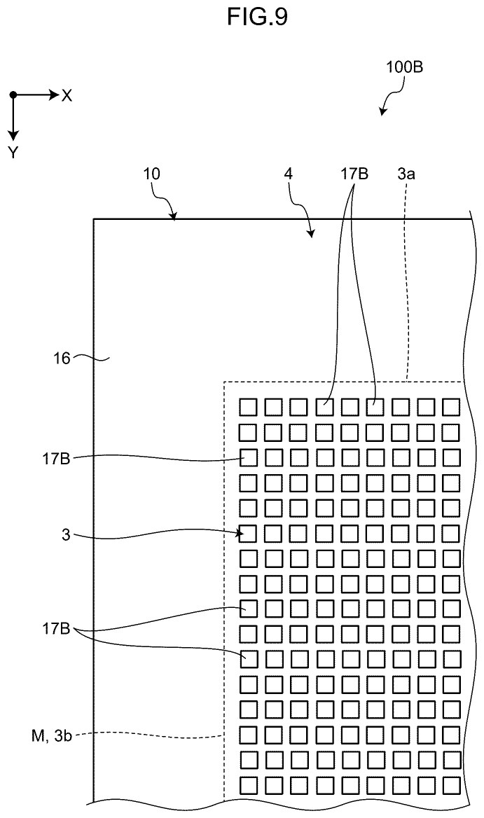

FIG. 9 is a view of part of the first surface of the array substrate according to the second modification viewed from the sensor layer side. As illustrated in FIG. 9, a recessed surface 17B of a detection device 100B according to the second modification is different from the first embodiment in that it has a quadrilateral shape in plan view. With the recessed surface 17B having the shape described above, the first surface 16 has a fine uneven structure and is hard to wet (water-repellent).

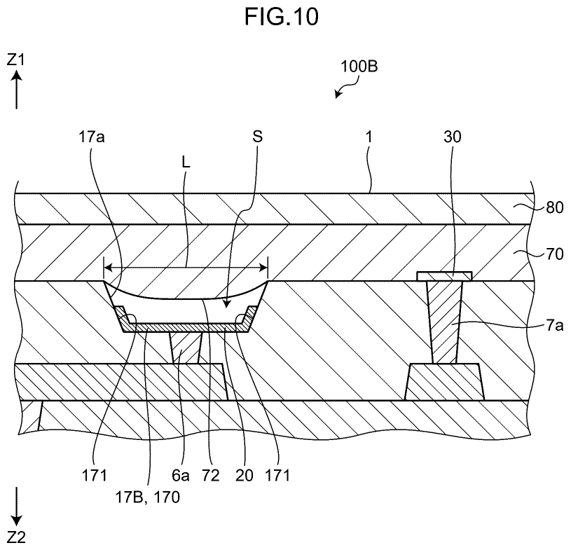

FIG. 10 is a sectional view of the recessed surface of the array substrate according to the second modification taken along the stacking direction. As illustrated in FIG. 10, the recessed surface 17B has a bottom surface 170 and four side surfaces 171 (only two of them are illustrated in FIG. 10). The bottom surface 170 extends in the planar direction. The distance L between the two facing side surfaces 171 gradually decreases along the second stacking direction Z2. In other words, the recessed surface 17B is formed in a truncated square pyramid shape. The detection electrode 20 is formed over the bottom surface 170 and the four side surfaces 171. The detection electrode 20 is not provided on the edge portion 17a of the recessed surface 17B (end of the side surface 171 in the first stacking direction Z1).

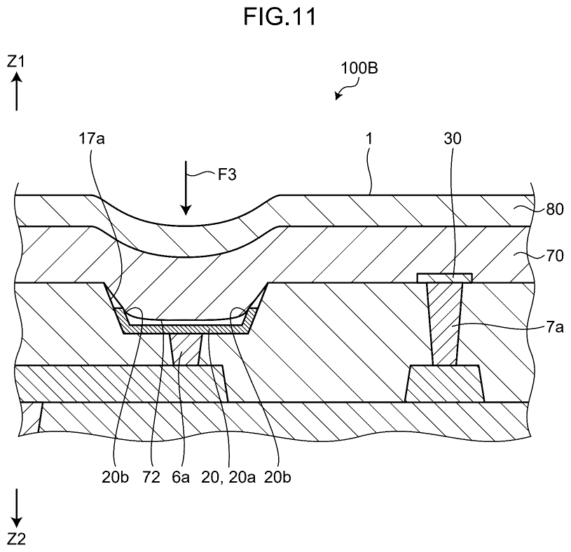

FIG. 11 is a sectional view schematically illustrating a state where force is applied to the detection device according to the second modification. According to the second modification, when relatively small force F3 is applied to the detection surface 1, the sensor layer 70 deforms in the second stacking direction Z2. Part of the protruding surface 72 of the sensor layer 70 comes into contact with the edge portion 20b of the detection electrode 20. As a result, a current flows from the common electrode 30 to the detection electrode 20 via the sensor layer 70.

When force larger than the force F3 is applied, the protruding surface 72 of the sensor layer 70 comes into contact not only with the edge portion 20b of the detection electrode 20 but also with the center 20a of the detection electrode 20, which is not specifically illustrated. Therefore, the amount of current flowing from the common electrode 30 to the detection electrode 20 is larger than when the force F3 is applied. Thus, also in the detection device 100B according to the second modification, the contact area of the sensor layer 70 in contact with the detection electrode 20 increases or decreases in proportion to the magnitude of the applied force. In the present disclosure, the second modification may be provided with the film 18 made of fluorine-based polyimide described in the first modification.

Next, third to sixth modifications are described.

### Third Modification

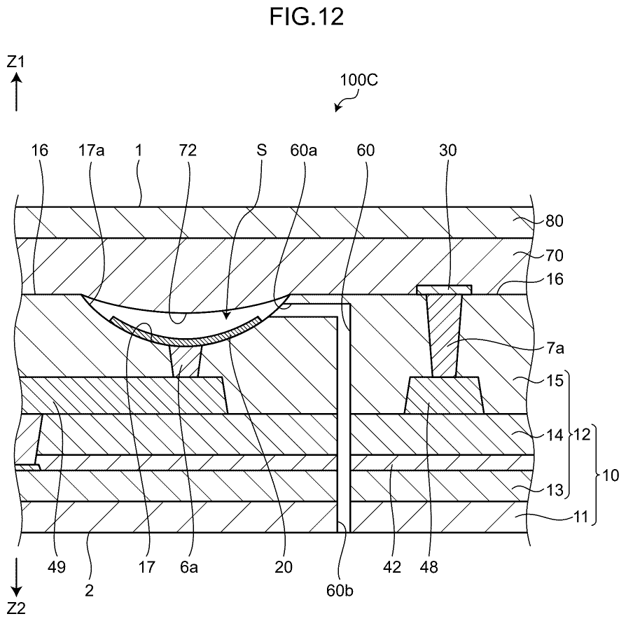

FIG. 12 is a sectional view of the array substrate according to the third modification taken along the stacking direction. As illustrated in FIG. 12, a detection device 100C according to the third modification is different from the first embodiment in that a communication hole 60 is formed. The communication hole 60 is a hole that connects the internal space S of the recessed surface 17 to the external space. The communication hole 60 is formed in the array substrate 10. A first end 60a of the communication hole 60 is formed in the edge portion 17a of the recessed surface 17. The communication hole 60 extends from the edge portion 17a of the recessed surface 17 in the planar direction and extends in the second stacking direction Z2. A second end 60b of the communication hole 60 is formed in the back surface 2 of the detection device 100C.

If the internal space S of the recessed surface 17 is sealed, the air pressure inside the recessed surface 17 increases due to the application of force, thereby making the sensor layer 70 less likely to come into contact with the detection electrode 20. According to the third modification, when force is applied, the gas in the internal space S of the recessed surface 17 passes through the communication hole 60 and is discharged into the external space. This configuration prevents the sensor layer 70 from being less likely to come into contact with the detection electrode 20.

### Fourth Modification

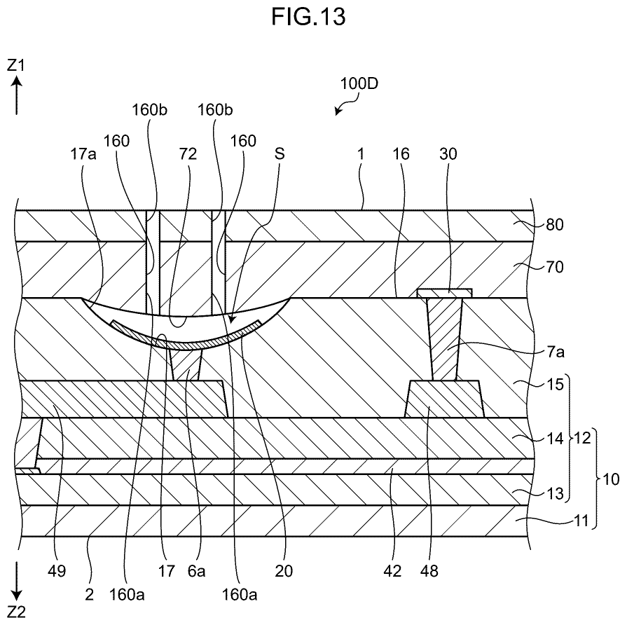

FIG. 13 is a sectional view of the array substrate according to the fourth modification taken along the stacking direction. As illustrated in FIG. 13, a detection device 100D according to the fourth modification is different from the third modification in that communication holes 160 are formed in the sensor layer 70 and the protective layer 80. A first end 160a of the communication hole 160 is formed in the protruding surface 72. The communication hole 160 extends from the protruding surface 72 in the first stacking direction Z1. A second end 160b of the communication hole 160 is formed in the detection surface 1 of the detection device 100D. Similarly to the third modification, the fourth modification also prevents the sensor layer 70 from being less likely to come into contact with the detection electrode 20.

### Fifth Modification

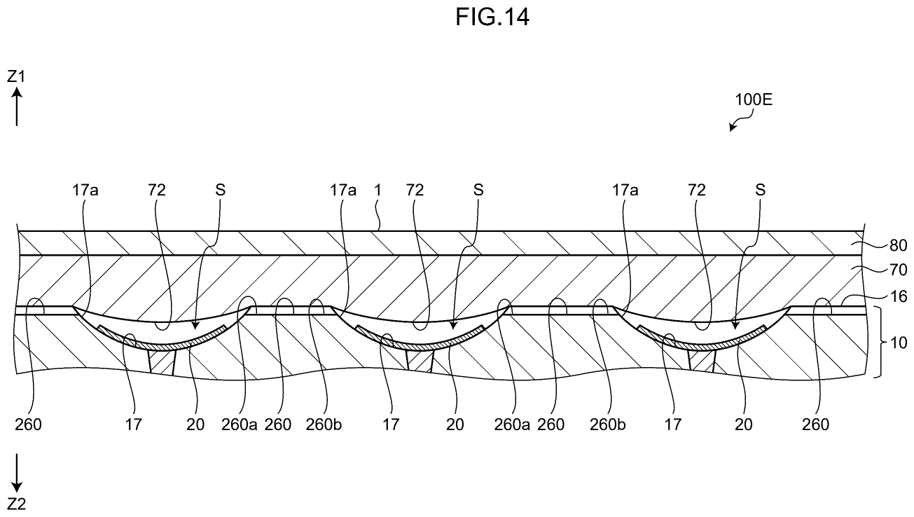

FIG. 14 is a sectional view of the array substrate according to the fifth modification taken along the stacking direction. As illustrated in FIG. 14, a detection device 100E according to the fifth modification is different from the third modification in that communication holes 260 are formed in the first surface 16 of the array substrate 10. The communication hole 260 is a groove recessed from the first surface 16 in the second stacking direction 22 and extending in the planar direction. A first end 260a of the communication hole 260 is formed in the edge portion 17a of the recessed surface 17. A second end 260b of the communication hole 260 is formed in the edge portion 17a of the recessed surface 17 adjacent to the recessed surface 17 to which the first end 260a is coupled. Therefore, the communication hole 260 connects the internal spaces S of the adjacent recessed surfaces 17. The communication holes 260 cause all the internal spaces S to communicate. According to the fifth modification, the gas in the internal space S the air pressure of which increases due to the application of force, moves to another internal space S through the communication hole 260. This configuration prevents the sensor layer 70 from being less likely to come into contact with the detection electrode 20.

### Sixth Modification

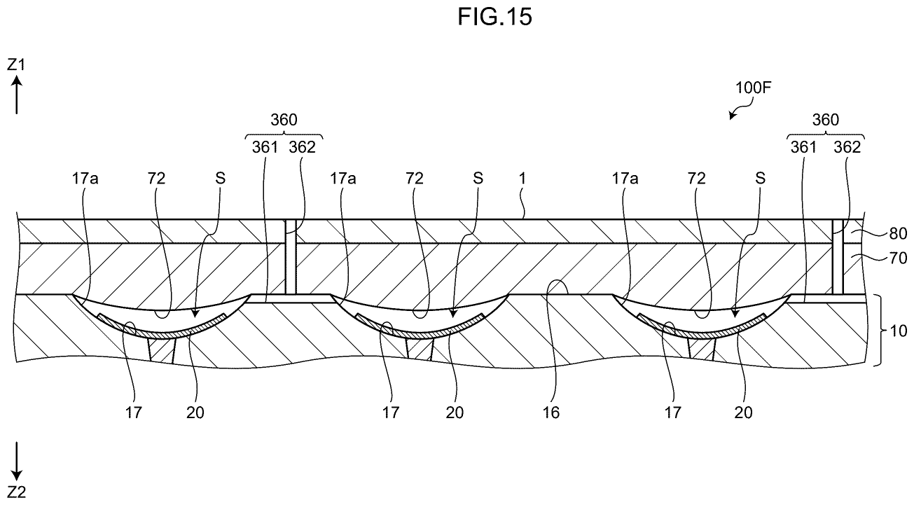

FIG. 15 is a sectional view of the array substrate according to the sixth modification taken along the stacking direction. As illustrated in FIG. 15, a detection device 100F according to the sixth modification is different from the third modification in that a communication hole 360 is formed across the array substrate 10, the sensor layer 70, and the protective layer 80. The communication hole 360 has a horizontal hole 361 and a vertical hole 362. The horizontal hole 361 is a groove recessed from the first surface 16 in the second stacking direction Z2 and extending in the planar direction. The vertical hole 362 is a hole extending from the horizontal hole 361 in the first stacking direction Z1 and passing through the sensor layer 70 and the protective layer 80. According to the sixth modification, the gas in the internal space S the air pressure of which increases due to the application of force flows through the horizontal hole 361 and then through the vertical hole 362 and is discharged in the first stacking direction Z1 of the detection surface 1. This configuration prevents the sensor layer 70 from being less likely to come into contact with the detection electrode 20. The communication hole according to the present disclosure may be provided in combination with the communication holes described in the third to the sixth modifications.

The embodiment and the modifications have been described above. While the sensor layer according to the embodiment is a sensor layer made of conductive resin material, for example, the sensor layer according to the present disclosure may be a sensor layer including a deformable insulating body made of silicone rubber or the like and conductive fine particles dispersed in the body. When no force is applied to such a sensor layer, the resistance is high. By contrast, when force is applied to the sensor layer, and the body is deformed, the conductive particles come into contact with or into proximity to each other, and the resistance of the sensor layer decreases. However, the material of the sensor layer according to the present disclosure is limited to material that can be printed on the first surface.

What is claimed is:

1. A detection device comprising
an array substrate and a sensor layer stacked in the order as stated, wherein
a direction in which the sensor layer is disposed when viewed from the array substrate is a first stacking direction,
a direction opposite to the first stacking direction is a second stacking direction,
the array substrate comprises:
a first surface facing in the first stacking direction;
a plurality of recessed surfaces recessed from the first surface in the second stacking direction; and
a plurality of detection electrodes provided on the respective recessed surfaces, wherein
the sensor layer is formed by curing conductive resin material printed on the first surface, and
the sensor layer and the detection electrodes are separated from each other.

2. The detection device according to claim 1, wherein
each of the recessed surfaces has an edge portion positioned at an end of the recessed surface in the first stacking direction, and
each of the detection electrodes is positioned in the second stacking direction with respect to the edge portion.

3. The detection device according to claim 2, wherein a film made of fluorine-based polyimide is formed on the edge portion of the recessed surface.

4. The detection device according to claim 1, wherein the recessed surface is formed in a hemispherical shape.

5. The detection device according to claim 1, wherein the recessed surface is formed in a truncated square pyramid shape.

6. The detection device according to claim 1, wherein at least one of the sensor layer and the array substrate has a communication hole that connects an internal space of the recessed surface to an external space or connects an internal space of the recessed surface to an internal space of another recessed surface different from the recessed surface.
